(19) United States
(12) Patent Application Publication
(10) Pub. No.: US 2009/0121459 A1
(43) Pub. Date: May 14, 2009

(54) Lighted airbag module

(75) Inventors: William Earl Bostick, St. Clair, MI (US); Jerome Bosch, St. Romeo, MI (US); Larry Michael Wilmot, Oxford, MI (US)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 11/979,952

(22) Filed: Nov. 9, 2007

(51) Int. Cl. B60R 21/215

(52) U.S. Cl. 280/728.3

(57) ABSTRACT

An airbag module includes an airbag cushion, a cover configured to break open to allow the airbag cushion to deploy into a vehicle occupant compartment, an emblem attached to the cover, and a light source connected to the cover and/or the emblem. The light source can provide a safe aesthetic airbag lighting option.

### BACKGROUND

The present invention relates generally to automotive airbags and emblem technology. More specifically, the invention relates generally to electroluminescent light elements that can be incorporated into an emblem, such as on a steering wheel.

### SUMMARY

One embodiment of the invention relates to an airbag module. The airbag module comprises an airbag cushion, a cover configured to break open to allow the airbag cushion to deploy into a vehicle occupant compartment, an emblem attached to the cover, and a light source connected to the cover and/or the emblem.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of the interior of a vehicle illustrating the location of a driver's side airbag according to an exemplary embodiment.

FIG. 2A is a front view of a steering wheel illustrating an emblem positioned on an airbag module according to an exemplary embodiment.

FIG. 2B is a cross section of the steering wheel illustrated in FIG. 2A according to an exemplary embodiment.

FIG. 3 is an expanded view of an airbag control module cover, electroluminescent light source, and emblem according to an exemplary embodiment.

FIG. 4A is an expanded view of an electroluminescent light source used in conjunction with an open emblem according to another exemplary embodiment.

FIG. 4B is a side view of an electroluminescent light source shown in FIG. 4A according to an exemplary embodiment.

FIG. 5A is an expanded view of an electroluminescent light source used in conjunction with a dome emblem according to another exemplary embodiment.

FIG. 5B is a side view of an electroluminescent light source shown in FIG. 5A according to an exemplary embodiment.

FIG. 6A is an expanded view of an electroluminescent light source used in conjunction with a hybrid emblem according to another exemplary embodiment.

FIG. 6B is a side view of an electroluminescent light source shown in FIG. 6A according to an exemplary embodiment.

FIG. 7 is cross-sectional view of an electroluminescent light source and a membrane switch according to an exemplary embodiment.

FIG. 8 is a perspective view of a warning system for a vehicle illustrating a tire pressure sensor, an information controls system, and a warning light positioned on a vehicle emblem.

### DETAILED DESCRIPTION

Airbags are provided in vehicles to protect the occupants in the event of a vehicle crash. It is desirable to retain the integrity of airbag module components, such as a cover (sometimes referred to as a deployment door), an emblem, and/or other decorative features placed on the surface of the deployable cover, during deployment of the airbag. It is desirable to prevent any such components from becoming detached during airbag deployment due to risk of injury to vehicle occupants from the projectiles. Any features incorporated with the airbag module should have robust attachment methods to withstand deployment forces throughout various environmental conditions. Attributes that can facilitate the retention during deployment are low mass as well as flexibility of the feature.

Lighting is used in many areas of automotive interiors and exteriors but is not currently used on the cover or door of an airbag module. Incorporating an electroluminescent light source on the door or cover can provide a low mass light source suitable to withstand the high energy of airbag deployment. The electroluminescent light source can be used in combination with flexible emblem technology. A flexible emblem is composed of a flexible plastic material that can withstand forces placed upon it created by an airbag during deployment. A flexible emblem resists shattering which can prevent emblem and/or airbag cushion damage due to sharp edges during airbag deployment. The thin profile of an electroluminescent light panel allows the light source to be used in places that other lighting technologies, e.g., LED or incandescent bulbs, do not fit. Additionally, the heat emitted by an electroluminescent light panel is low compared to other lighting technologies.

In an exemplary embodiment, the electroluminescent light source can be attached to an airbag cover and/or emblem, positioned between the cover and emblem, therefore providing a uniform light visible to vehicle occupants. The power source to provide the electroluminescent light source may be located in a remote non critical area of the airbag module or other part of the vehicle.

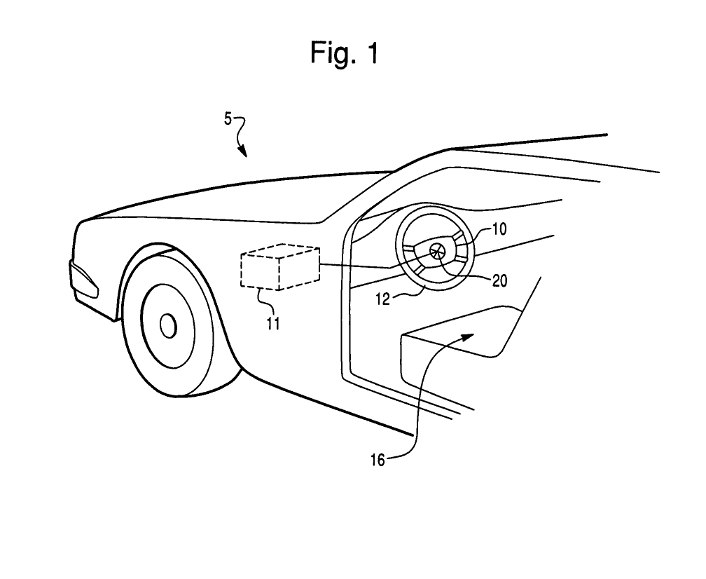

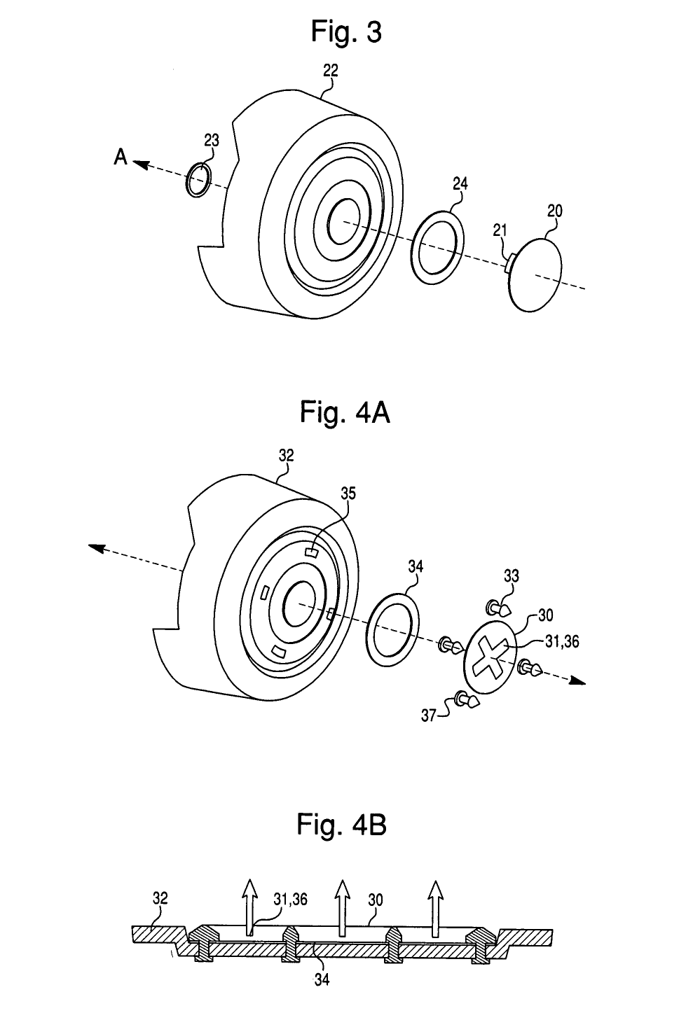

FIG. 1 illustrates a vehicle 5 according to an exemplary embodiment. Vehicle 5 is shown with an air bag module 10 positioned on the driver's side and mounted generally in the center of the steering wheel 12. In the event of a vehicle crash, airbag module 10 is configured to deploy an airbag cushion 14 (shown in FIG. 3) into a vehicle occupant compartment 16. An emblem 20 is shown mounted generally center on airbag module 10. Emblem 20 can be lit by an electroluminescent light source (not shown) powered by power source 11. Power source 11 can be located as shown in FIG. 1 or positioned in any other remote non critical area of airbag module 10 or vehicle 5.

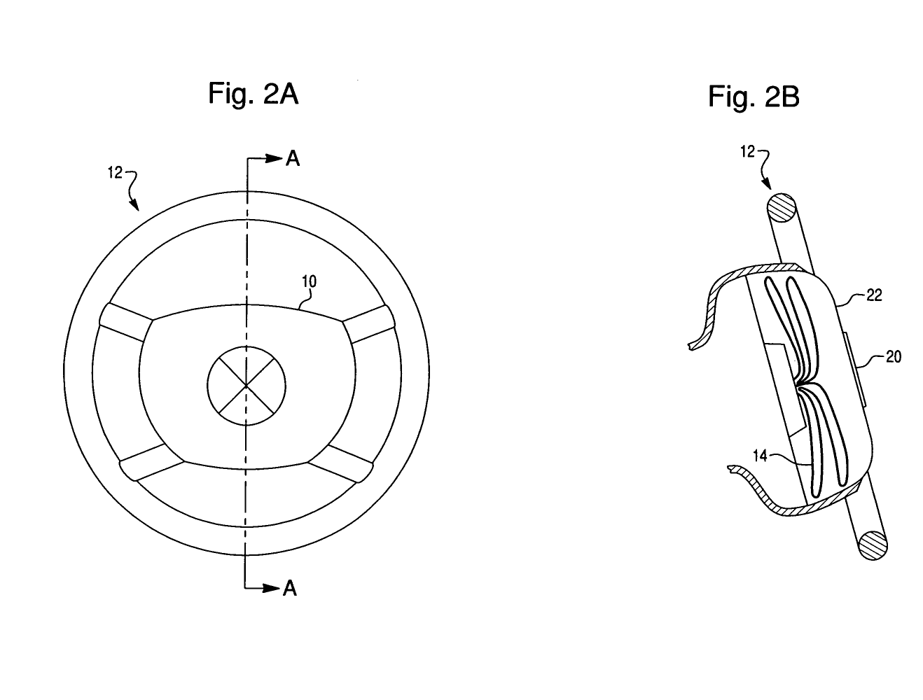

In FIGS. 2A-2B, steering wheel 12 is shown configured with an airbag module 10. Airbag module 10 is generally centered on steering wheel 12 and includes an airbag cushion 14, an airbag cover 22 configured to break open to allow the airbag cushion 14 to deploy in the event of a vehicle crash, an emblem 20 attached to the cover 22, and a light source 24 connected to airbag cover 22 and/or emblem 20. Light source 24 is positioned between the airbag cover 22 and emblem 20, making the light source 24 visible to a vehicle occupant, which complements existing lighting within the vehicle interior and can offer improved brand recognition during low light conditions, while maintaining a similar appearance during daylight hours.

An expanded view of airbag module cover 22 with light source 24 and emblem 20 is illustrated in FIG. 3. Light source 24, positioned between cover 22 and emblem 20, can be bonded to a back surface 18 of emblem 20, which can advantageously provide a thin profile and a low mass lighting solution. A threaded stud 21 may be positioned on the back side of emblem 20 and can connect with a nut 23 located on cover 22 to provide a method for mounting emblem 20. Nut 23 e.g., can be a Tinnerman® nut, a speed nut, a push nut, etc.

Emblem 20 can be mounted to back surface 18 of the cover 22 utilizing other existing fastening technology such as an adhesive, heat staking, ultrasonic welding, peel off adhesives, etc.

In another exemplary embodiment, illustrated in FIGS. 4A-4B, emblem 30 has an open area 36 carved into a design 31, such as an “X”. Light source 34 is mounted to emblem 30 and positioned between emblem 30 and the airbag cover 32. Light source 34 emits light rays through the open area 36, therefore making light source 34 directly visible to the vehicle occupant. Emblem 30 may be flexible to prevent shattering and damage to an airbag cushion (not shown) due to sharp edges seen on non-flexible emblems. Emblem 30 can be mounted using a current emblem attachment method such as heat staking and/or ultrasonic welding. In heat staking and/or ultrasonic welding, a compression probe 33 located on emblem 30 fits into a mating socket 35 positioned on the airbag cover 32. The probe 33 can then be deformed by melting the probe material, which is generally plastic. The melting of the material forms a head which mechanically locks the emblem 30 and airbag cover together.

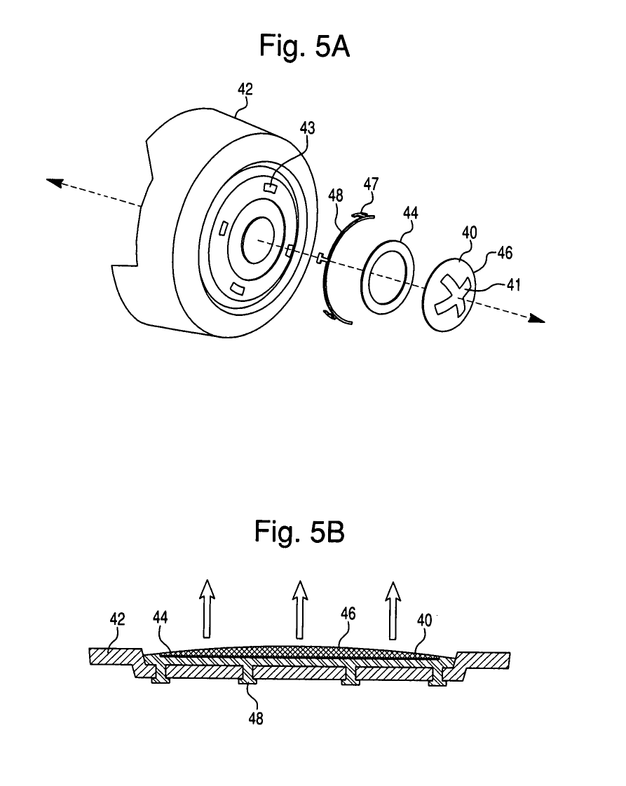

Another exemplary embodiment is illustrated in FIGS. 5A-5B. Emblem 40 is designed with the front contour of the emblem resembling a dome. In this embodiment, the emblem 40 may include a design 41 that may be screen printed onto the front side 46 of emblem 40 using translucent and/or opaque inks that allows the light source 44 to either shine through or be blocked, depending on the desired appearance for the emblem. Light source 44 is positioned between emblem 40 and airbag cover 42 and can be bonded to a bezel fastener 48 that can be mechanically fastened to the airbag cover 42. Bezel fastener 48 contains pins 47 that can be snapped into mating sockets 43 occurring on airbag cover 42 positioned to receive a plurality of pins 47. Once the pins are snapped in the mating sockets 43, the ends of the pins 47 can be deformed to prohibit movement of the bezel fastener 48.

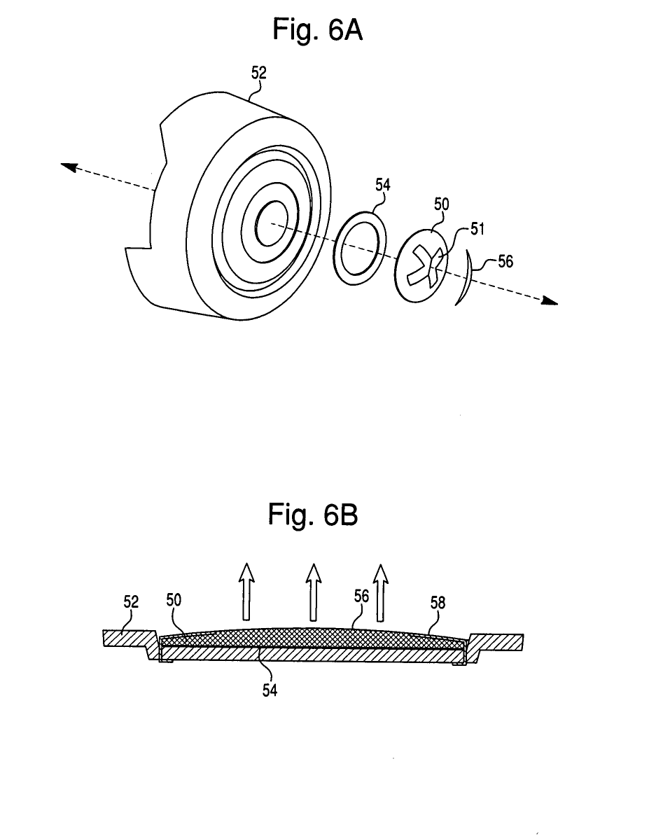

FIGS. 6A-6B illustrate another exemplary embodiment of an emblem 50 that is composed of an aluminum shell 58. The design 51 of emblem 50 comprises holes stamped out of the aluminum shell 58. In this embodiment, a translucent plastic component 56 is injection molded through the back side of aluminum shell 58. Light source 54 is positioned between the emblem 50 and airbag cover 52. The light emitted from light source 54 is visible through plastic component 56. Emblem 50 can be attached using tabs or other existing attachment methods.

In an exemplary embodiment, the light source described in this disclosure is an electroluminescent panel. Electroluminescent technology provides uniform light distribution, thus eliminating the need to use special optical features to attenuate hot spots created by other lighting technologies such as LED or incandescent bulbs. Additionally, the thin profile of an electroluminescent panel allows placing the light source in places other lighting technologies would not fit, reducing packaging to a minimum. Electroluminescent technology emits a lower amount of heat compared to other technologies.

In an exemplary embodiment, specific areas of a light source may be weakened to allow for controlled separation during airbag deployment, therefore advantageously allowing the lighting technology to be combined with frangible emblems or decorative elements currently used on deployable airbag surfaces.

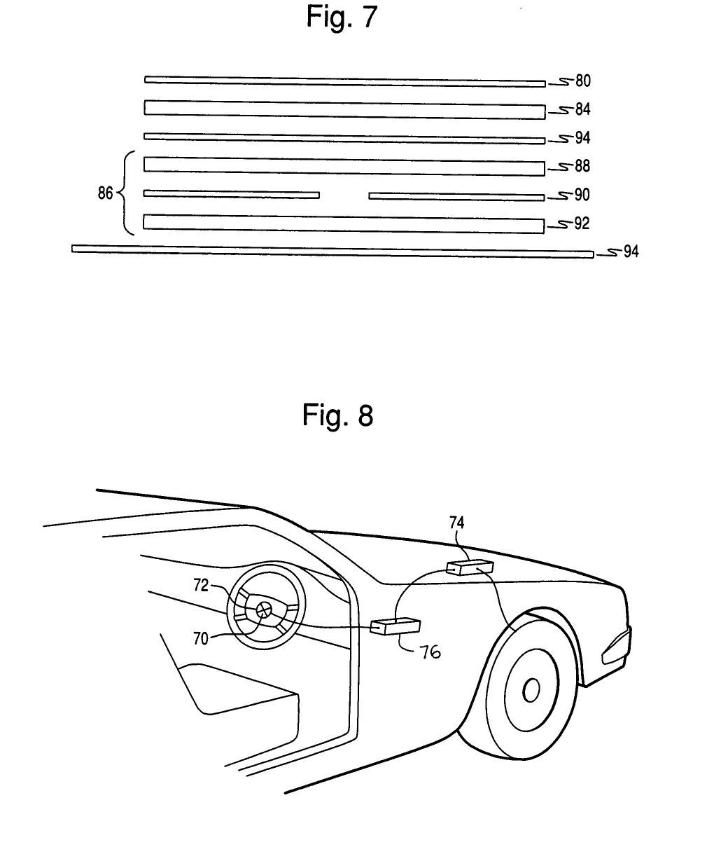

In an exemplary embodiment, a light source may be used in conjunction with a low profile switch technology, e.g., a membrane switch 76, to incorporate the control of light emitted from the light source, as illustrated in FIG. 7. The membrane switch includes a top circuit 88, and adhesive or spacer 90, and a bottom circuit 92, and is positioned beneath the light source 84. Light source 84 is positioned beneath an optional graphic overly, i.e., emblem 80. In this embodiment, an occupant of the vehicle can apply pressure to the emblem 80 and activate a circuit associated with the membrane switch 86 and light source 84. Both the light source 84 and membrane switch 86 can be attached to their respective mounted surfaces using an adhesive 94 or other fastening surface.

In an exemplary embodiment illustrated in FIG. 8, a light source can be incorporated with other safety systems or sensors within the vehicle and used as a warning or informational system. In this embodiment, a light source could emit a warning light upon receiving a signal from a safety controller or sensor located within the vehicle. As shown in FIG. 8, a low tire pressure could be indicated by a warning light 72 on the emblem 70. A tire pressure sensor 74 could sense a low tire pressure and send a signal to an information control system 76. The information control system 76 could process the information received by the tire pressure sensor 74 and send a signal to power a warning light 72 associated with low tire pressure located on emblem 70.

In another exemplary embodiment, the utilization of electroluminescent light for decorative lighting can be implemented into deployable and non-deployable airbag surfaces.

In other exemplary embodiments, a plurality of light sources can be incorporated into an emblem to provide various lighting options for the emblem. For example, varying colors, different levels of light intensity, etc. can be used to give each emblem a distinct look.

It is important to note that the construction and arrangement of the electroluminescent light source as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the description. For example, elements shown as integrally formed may be constructed of multiple parts or elements, the position of the elements may be reversed or otherwise varied, and the nature or number of discrete elements or positions may be altered or varied. Other substitutions, modifications, changes and omissions may be made in the design, operating conditions and arrangement of the exemplary embodiments.

What is claimed is:

1. An airbag module, comprising:
an airbag cushion;
a cover configured to break open to allow the airbag cushion to deploy into a vehicle occupant compartment;
an emblem attached to the cover; and
a light source connected to the cover and/or the emblem.

2. The airbag module of claim 1, wherein the light source is positioned between the cover and the emblem.

3. The airbag module of claim 1, wherein the light source is directly visible to a vehicle occupant.

4. The airbag module of claim 1, wherein the light source is bonded to a back surface of the emblem.

5. The airbag module of claim 4, wherein the emblem comprises at least one open area to allow light from the light source to be directly visible by a vehicle occupant.

6. The airbag module of claim 4, wherein the emblem includes a translucent portion to allow the light source to emit light through the translucent portion.

7. The airbag module of claim 4, wherein the emblem includes an opaque portion to block the light source from emitting light at the opaque portion.

8. The airbag module of claim 1, wherein the light source is bonded to a bezel fastened to the cover.

9. The airbag module of claim 1, wherein the light source is electroluminescent.

10. The airbag module of claim 1, wherein the light source includes an area of predetermined weakness configured to break to allow for the light source to separate during deployment of the airbag.

11. The airbag module of claim 1, further comprising a membrane switch to control light emitted from the light source.

12. The airbag module of claim 1, further comprising a power converter for the light source, and wherein the power converter is located remote from the light source in the airbag module.

13. The airbag module of claim 1, wherein the emblem is a flexible emblem.

14. The airbag module of claim 1, further comprising a safety controller, and wherein the light source emits light upon receiving a signal from the safety controller.

15. The airbag module of claim 1, further comprising a second light source.

16. An airbag module, comprising:
an airbag cushion;
a cover configured to break open to allow the airbag cushion to deploy into a vehicle occupant compartment;
an emblem attached to the cover; and
a light source positioned so that light is visible through the emblem to an occupant of the vehicle.
